(19) United States
(12) Patent Application Publication
(10) Pub. No.: US 2008/0170612 A1
(43) Pub. Date: Jul. 17, 2008

(54) METHOD AND APPARATUS FOR GEOMETRIC TRANSFORMATION IN VIDEO REPRODUCTION

(75) Inventor: Li ZHOU, Suzhou (CN)

Correspondence Address: FREESCALE SEMICONDUCTOR, INC.;LAW DEPARTMENT, 7700 WEST PARMER LANE MD:TX32/PL02, AUSTIN, TX, 78729, US

(73) Assignee: FREESCALE SEMICONDUCTOR, INC., Austin, TX (US)

(21) Appl. No.: 11/956,341

(22) Filed: Dec. 14, 2007

(30) Foreign Application Priority Data
Jan. 15, 2007 (CN) 200710002381.7

(51) Int. Cl. H04N 7/24

(52) U.S. Cl. 375/240.03; 375/E07.005

(57) ABSTRACT

A method of geometric transformation in video reproduction and an apparatus for video reproduction includes entropy decoding, re-ordering, inverse quantization, inverse transform, inter/intra-reconstruction, compensating the reconstructed frames with the matrix series obtained after the step of inverse transform, and geometrically transforming the matrix series after the re-ordering step but before the compensating step. The step of inter/intra-reconstruction is configured so that a prediction direction and source pixel accessing address are adapted to the geometric transformation performed in the geometric transforming step.

### BACKGROUND OF THE INVENTION

The present invention relates to video reproduction, and more particularly to a method of geometric transformation in video reproduction and an apparatus for video reproduction.

Many current consumer electronics devices support rotation and mirror functions for converting a video frame by a specific angle as specified by an application program. In most video applications, rotation refers to left/right 90, 180 and 270 degree conversion, and mirror refers to horizontal and vertical conversion, as shown in FIG. 1. Of course, the rotation and mirror may be of any other directions and/or angles. Rotation and mirror is not a component of a video processing standard, such as H264/AVC, MPEG2, MPEG4, etc., but is generally a part of video frame pre/post processing.

A conventional video decoding architecture relating to frame inter/intra-reconstruction processing is shown in FIG. 2. As shown in FIG. 2, a conventional video decoding apparatus 200 includes an entropy decoder 212, inverse transform/processing means 214, inter/intra-reconstruction means 216, deblock filter 218 and compensating means 220. The inter/intra prediction coding and decoding of video are well-known in the art and thus a detailed description is not provided here.

Inter/intra-reconstruction of video frames requires reference frames, that is, previously decoded frames, which are stored in reference frame memories 204.

The conventional rotation and mirror means is realized outside the video decoding loop, that is, outside the video decoder 200. That is to say, rotation and mirror is realized after the video decoding process.

Because frame inter/intra-reconstruction requires a reference frame without rotation and mirror to reconstruct the current frame, the decoded frame without rotation and mirror is stored in an external, current decoded frame memory 201 for later frame reconstruction and prediction. A rotation and mirror unit 202 receives current decoded frame data and executes rotation and mirror and outputs results thereof to an external display memory 203, which is used only for display. Thus, rotation and mirror processing is outside the loop of video decoding, which involves frame inter/intra-reconstruction. The display memory 203 and current decoded frame memory 201 are separate memory buffers, which causes one more frame buffer assignments and increases frame memory bandwidth loading.

It would be advantageous to provide rotation and mirror functions as part of the video processing loop. It would also be advantageous to be able to combine the current decoded frame memory and the display memory.

### BRIEF DESCRIPTION OF THE DRAWINGS

The present invention is illustrated by way of example and is not limited by the accompanying figures, in which like references indicate similar elements.

FIG. 1 shows some examples of image rotation and mirror;

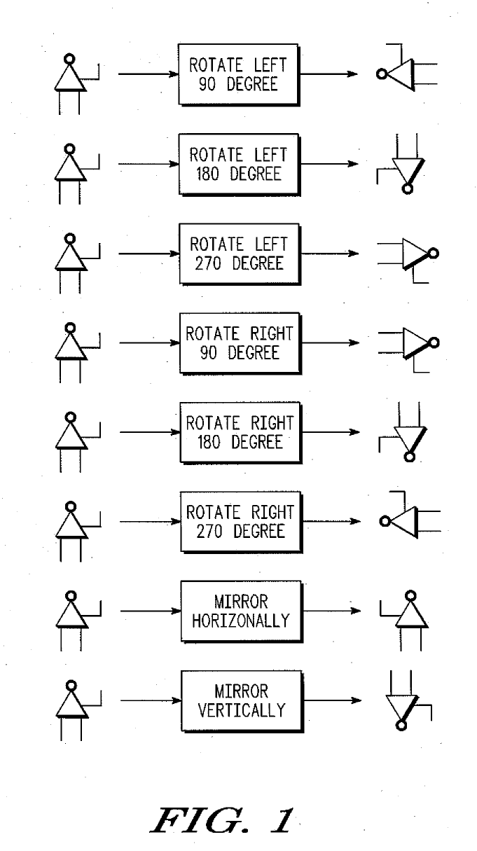

FIG. 2 is schematic block diagram of a conventional video decoding architecture with post-processing rotation and mirror;

FIG. 3 is schematic block diagram of a decoding architecture with in-loop rotation and mirror according to an embodiment of the present invention;

FIG. 4 is a more detailed block diagram of a conventional video decoding architecture with post-processing rotation and mirror;

FIG. 5 is a more detailed schematic block diagram of the decoding architecture with in-loop rotation and mirror of FIG. 3;

FIG. 6 is a schematic view illustrating a rotation operation in accordance with the present invention;

FIG. 7 is a schematic view illustrating a mirror operation in accordance with the present invention; and

FIG. 8 is a flow chart illustrating the video reproduction method according to an embodiment of the present invention.

### DETAILED DESCRIPTION OF THE PREFERRED EMBODIMENTS

For overcoming the problems discussed above, the present invention provides an in-loop rotation and mirror method for video decoding. A rotation and mirror function is realized in a video decoding loop. According to the present invention, a display frame buffer and decoded frame buffer are merged together, and thus additional frame buffer assignments and bandwidth loading are saved.

More specifically, the present invention provides a method of geometric transformation in video reproduction that includes entropy decoding, re-ordering, inverse quantization, inverse transform, inter/intra-reconstruction, and compensating the reconstructed frames with the matrix series obtained after the step of inverse transform. The method further comprises a step of geometrically transforming the matrix series after the re-ordering step but before the compensating step. The inter/intra-reconstruction step is configured so that a prediction direction and source pixel accessing address are adapted to the geometric transformation performed in the geometric transforming step.

The present invention also provides an apparatus for video reproduction, including an entropy decoder, re-ordering means, an inverse quantizer, an inverse transformer, inter-reconstruction means, intra-reconstruction means and compensating means for compensating the frames reconstructed by one of the inter-reconstruction means and the intra-reconstruction means with a matrix series obtained by the inverse transformer. The apparatus also includes a geometric transformer for geometrically transforming the matrix series obtained by the re-ordering means, the inverse quantizer or the inverse transformer. The inter-reconstruction means and the intra-reconstruction means are configured so that the prediction direction and source pixel accessing address are adapted to the geometric transformation performed in the geometric transformer.

Also provided is a method of geometric transformation in video reproduction, including entropy decoding a video input signal having a plurality of frames; re-ordering the entropy decoded signal; inverse quantization of the re-ordered signal; inverse transformation of the inverse quantized signal; inter/intra-reconstruction under the control of the entropy decoded signal; compensating the reconstructed frames with the matrix series obtained after the step of inverse transform; and geometrically transforming the matrix series after the re-ordering step but before the compensating step. The inter/intra-reconstruction step is configured so that a prediction direction and source pixel accessing address are adapted to the geometric transformation performed in the geometric transforming step.

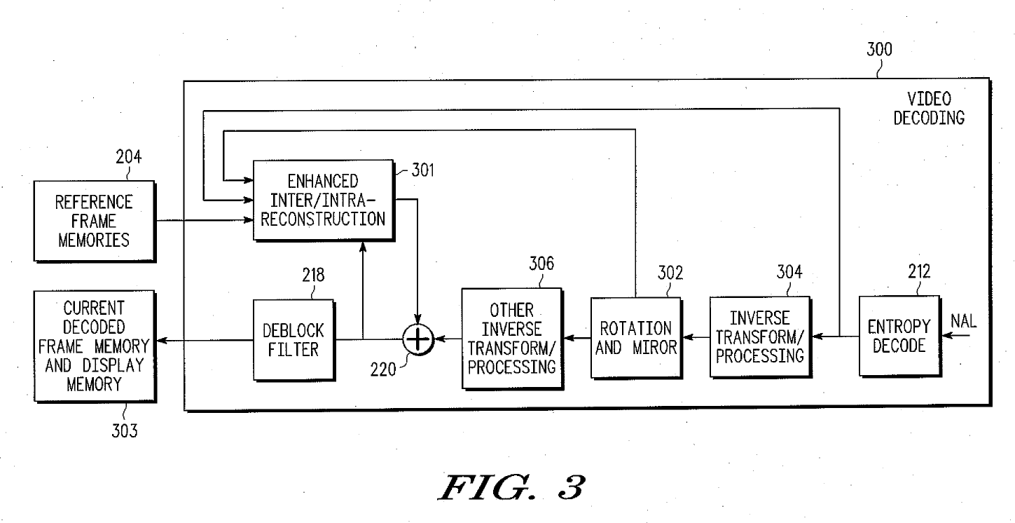

The basic idea of the in-loop rotation and mirror of the present invention is shown in FIG. 3. According to the present invention, a video decoder 300 performs the rotation and mirror functions as part of the process of inverse transform/processing, which uses an enhanced inter/intra-reconstruction means 301. A rotation and mirror unit 302 performs rotation and/or mirror and the enhanced inter/intra-reconstruction means 301 performs inter/intra-reconstruction based on a rotated reference frame and predicting direction or motion vectors modified according to the rotation and/or mirror performed in the rotation and mirror unit 302.

Since the decoded frames, including the reference frames and the current decoded frame to be displayed, are already rotated and/or mirrored, the current decoded frame memory and the display memory comprise a single memory 303. Thus one frame buffer assignment and loading can be saved when compared to the conventional video decoder 200.

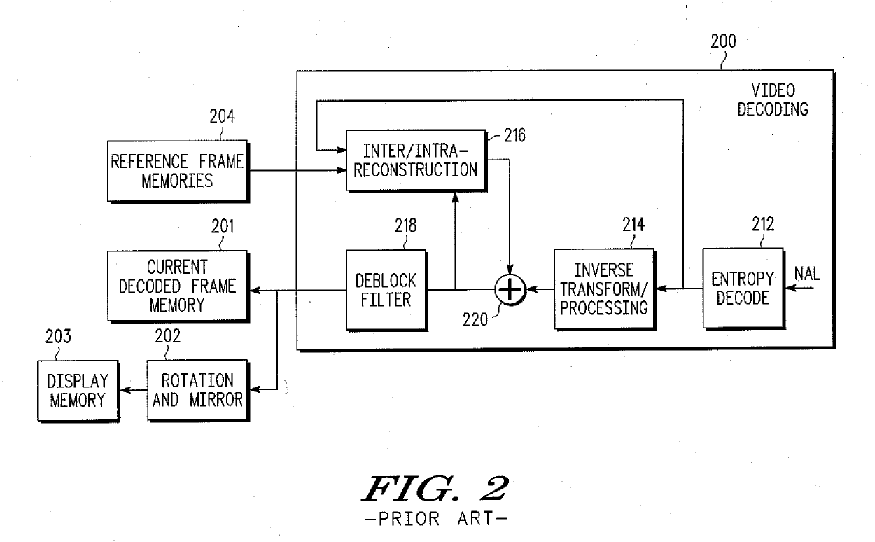

Note that as is well-known in the art, the inverse transform/processing means 214 shown in FIG. 2 performs a plurality of functions. Since the rotation and/or mirror operation are performed during the inverse transform processing, that is, between two consecutive inverse transform processing operations, the inverse transform/processing means 214 of FIG. 2 is shown as an inverse transform/processing means 304 and other inverse transform/processing means 306. Alternatively, the rotation and/or mirror operation may be performed after all the inverse transform/processing operations have been completed. In such a case, there will be no other inverse transform/processing means 306 in FIG. 3.

The rotation and/or mirror operation in the rotation and mirror unit 302 may be performed in any manner, including a conventional manner. In brief, the frame rotation and/or mirror is simply the rotation and/or mirror of the corresponding decoded matrix, which is well-known in the art and will be discussed later. With respect to the enhanced inter/intra-reconstruction means 301, modification of the programming of the inter/intra-reconstruction means 216 and some additional control codes are used. In view of the teachings of this application and the discussion herein on how to adjust the motion vector, the actual programming is considered to be routine work that may be done by one of ordinary skill in the art.

The motion vector may be determined by the address of the reference block/pixel in the reference frame and the address of the current decoded block/pixel in the current decoded frame. When rotating or mirroring a frame, both the address of the reference pixel/block in the reference frame and the address of the current decoded pixel/block in the current decoded frame will change. The new addresses are obtained based on the old addresses and the rotation/mirror operation with the new motion vector being expressed by the old motion vector and the rotation/mirror operation. Such expressions constitute the basis of the control to the enhanced inter/intra-reconstruction.

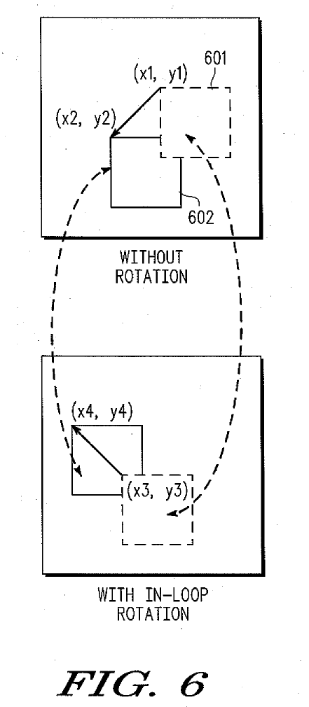

FIG. 6 shows an example of rotating 90 degrees clockwise in inter-reconstruction of a current macro block 602. Here, as an example, the intra-reconstruction mode is mode 3 described in the H.264 video decoding standard. If, without rotation, the current macro block 602 is predicted using a reference macro block 601. The motion vector as indicated by the arrow may be expressed by the addresses of the current macro block 602 and the reference macro block 601, such as from (x₁, y₁) to (x₂, y₂). The upper-left corner of the frame is the origin; the horizontal axis is the x-axis, the vertical y; and the address of a macro-block is the address of the upper-left pixel in the macro-block. For the same macro-block with rotation, the addresses will be (x₃, y₃) and (x₄, y₄), respectively. Through simple mathematical reasoning, the following expressions may be obtained:

x3=H−y1−block width

y3=x1

x4=H−y2−block width

y4=x2

where H is the height of the frame.

The motion vector may also be expressed by the address of the reference macro-block (which may also be referred to as source pixel accessing address) and the direction of the motion vector (which may also be referred to as prediction direction), that is, (x2,y2)−(x1,y1)=(x2−x1,y2−y1)=(a,b). Then, if with rotation, the direction of the motion vector will be:

(x4,y4)−(x3,y3)=(x4−x3,y4−y3)=(−y2+y1,x2−x1)=(−b,a)

The above is taking inter-reconstruction with 90 degrees right rotation as an example. Obviously, a person skilled in the art could derive other transformation expressions under rotation/mirror in any direction and/or of any degrees.

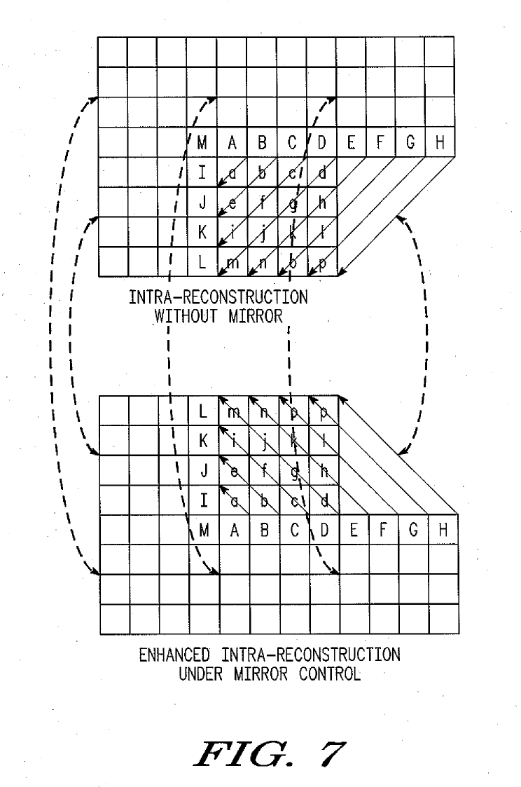

FIG. 7 shows an example of intra-reconstruction with vertical mirror control. Here, as an example, the intra-reconstruction mode is mode 3 described in the H.264 video decoding standard. If without mirror, the pixels ‘a’ to ‘p’ are predicted from reference pixels A to M. For enhanced intra-prediction with vertical mirror, the prediction mode is not changed and the intra-prediction algorithm defined in the standard is also not changed. What will be changed is the address of each pixel, including the pixels to be predicted and the reference pixels. The change of address may be derived by simple mathematical calculation.

Supposing the address of a pixel is (x,y) (Also, the upper-left corner of the frame is the origin, the horizontal axis is x axis, and the vertical, y), then after vertical mirror, its address will be changed to (x, frame height-y). Similarly, the address of a reference pixel may be referred to as source pixel accessing address, and the addresses of a pixel to be predicted and the corresponding reference pixel determine the prediction direction.

The above is taking intra-reconstruction mode 3 (in H.264 standard) with vertical mirror as an example. Obviously, a person skilled in the art could derive other transformation expressions of pixel address under any rotation/mirror direction and/or under any mode.

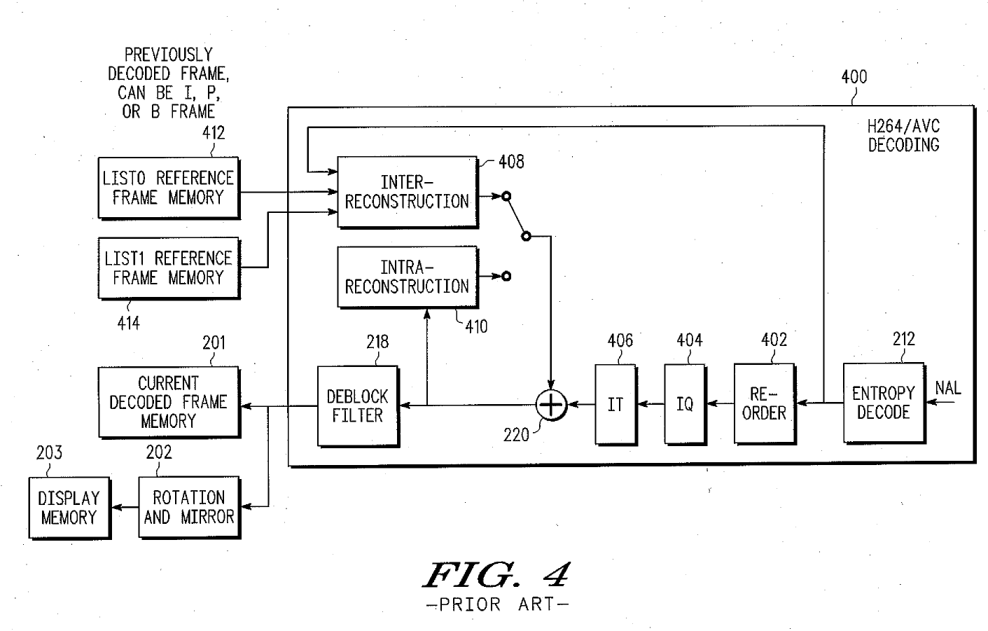

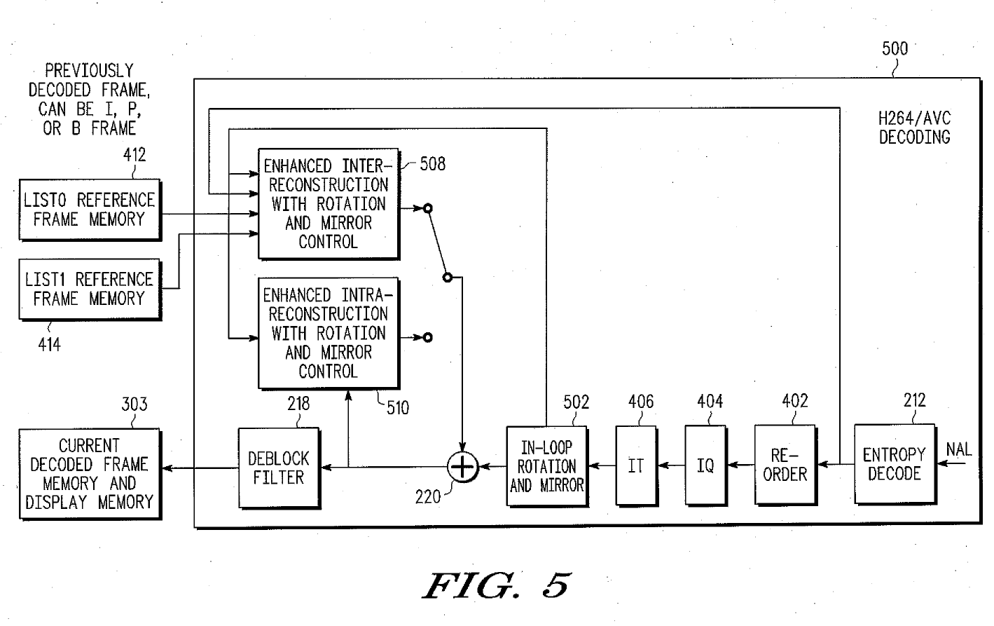

The above examples describe one example of the present invention. As will be appreciated by those of skill in the art, there are many video decoding standards and the present invention may be applied to all such standards in terms of the basic architecture. The following is an example of the application of the invention in H.264/AVC video decoding standard. Also, the components in FIGS. 4 and 5 bearing the same reference signs as in FIGS. 2 and 3 have the same functions as in FIGS. 2 and 3 and the detailed description thereof is omitted.

Referring now to FIG. 4, a conventional apparatus for video reproduction 400 comprises an entropy decoder 212, re-ordering means 402, an inverse quantizer (IQ) 404, an inverse transformer (IT) 406, inter-reconstruction means 408, intra-reconstruction means 410, deblock filter 218, and compensation means 220. The entropy decoder 212 decodes the input stream NAL and obtains decoded signals, which are re-ordered by the re-ordering means 402 to form a first matrix series. The first matrix series are inverse quantized and inverse transformed by the IQ 404 and IT 406 respectively and become second matrix series and third matrix series respectively. The inter-reconstruction means 408 and the intra-reconstruction means 410 perform inter-frame prediction and intra-frame prediction, respectively, using prediction information extracted by the entropy decoder 212 from the input stream NAL. The compensating means 220 compensates the frames re-constructed by either the inter-reconstruction means 408 or the intra-reconstruction means 410 with the third matrix series obtained by the inverse transformer 406. Thus, final frames to be displayed are obtained.

The reference frames used by the inter-reconstruction means 408 and intra-reconstruction means 410 are held in frame memories, shown as a first frame memory 412 for holding list 0 reference frames and a second frame memory 414 for holding list 1 reference frames. The current decoded frame memory 201, display memory 203 and geometric transformer 202 for performing geometric transformation such as rotation and/or mirror, were previously described with reference to FIG. 2. In addition, the deblock filter 218 is used to remove block noise from the compensated frames.

FIG. 5 shows a video decoder apparatus 500 in accordance with an embodiment of the present invention. The video decoder apparatus 500, as compared to the video decoder apparatus 400, further comprises an in-loop rotation and mirror unit 502 that receives the third matrix series from the IT 406 and geometrically transforms the third matrix series. An inter-reconstruction means 508 and intra-reconstruction means 510 are configured so that the prediction direction and source pixel accessing address are adapted to the geometric transformation performed by the in-loop rotation and mirror unit 502. A current decoded frame memory and display memory 303 is provided that combines the current-decoded frame memory 201 and the display memory 203, which saves one frame of the buffer assignment and memory bandwidth loading.

In the embodiment shown in FIG. 5, the in-loop rotation and mirror unit 502 is positioned after the IT 406, which generates the third matrix series output. In alternative embodiments, the in-loop rotation and mirror unit may be positioned between the IT 406 and the IQ 404 for geometrically transforming the second matrix series output from the latter, or between the IQ 404 and the re-ordering means 402 for geometrically transforming the first matrix series output from the latter.

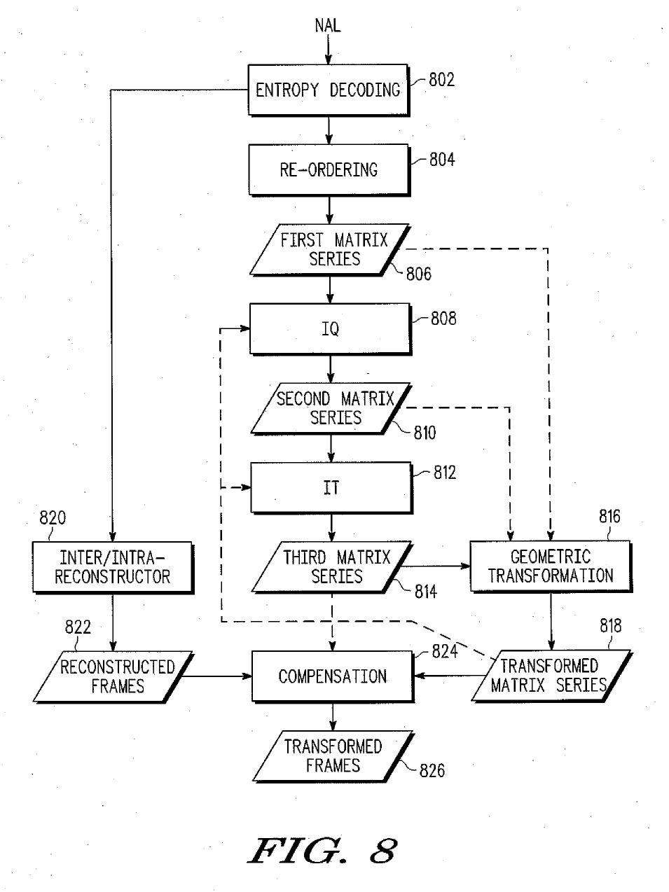

Above has been described an apparatus for video reproduction according to the present invention. Below a method of geometric transformation in video reproduction according to the present invention will be described in detail with reference to FIG. 8.

As shown in FIG. 8, a video input signal, such as the NAL input stream, is firstly entropy decoded at step 802. The decoded signal is then re-ordered at step 804 and a first matrix series 806 is obtained. The first matrix series 806 is inverse quantized at step 808, which generates the second matrix series 810. An inverse transformation is performed on the second matrix series 810 at step 812, which generates a third matrix series 814. The third matrix series 814 may be geometrically transformed at step 816 to generate a transformed matrix series 818. As discussed above, geometric transformation may comprise rotation of any degrees in any direction and/or mirror in any direction.

Substantially simultaneously with the above operations, inter/intra-reconstruction is performed at step 820 under the control of the information obtained from the entropy decoding step 802, which generates reconstructed frames 822. According to the invention, the inter/intra-reconstruction step 820 is configured so that the prediction direction and source pixel accessing address are adapted to the geometric transformation performed in the geometric transformation step 816, as discussed above.

The reconstructed frames 822 are compensated with the geometrically transformed matrix series 818 in a compensation step 824 and geometrically transformed frames 826 are obtained and may be displayed.

In an alternative embodiment, the method may further comprise a deblock filtering step for removing block noise from the geometrically transformed frames 826.

In another alternative embodiment, the geometric transformation step 816 may be located between the re-ordering step 804 and the IQ step 808 or between the IQ step 808 and the IT step 812. In such cases, the third matrix series 814 are already a geometrically transformed matrix series and may be used directly by the compensation step 824 to compensate the reconstructed frames 822.

While the invention has been described with reference to specific embodiments disclosed herein, it is not confined to the details set forth herein, and this application is intended to cover all the variations or equivalents that are obvious to a person skilled in the art having read the specification.

1. A method of geometric transformation in video reproduction that includes entropy decoding, re-ordering, inverse quantization, inverse transform, inter/intra-reconstruction, and compensating the reconstructed frames with the matrix series obtained after the step of inverse transform, the method further comprising a step of:
geometrically transforming the matrix series after the re-ordering step but before the compensating step, wherein the inter/intra-reconstruction step is configured so that a prediction direction and source pixel accessing address are adapted to the geometric transformation performed in the geometric transforming step.

2. The method of geometric transformation of claim 1, wherein the geometric transforming step comprises rotating the matrix series.

3. The method of geometric transformation of claim 2, wherein the geometric transforming step further comprises mirroring the matrix series.

4. The method of geometric transformation of claim 1, wherein the geometric transforming step is located between one of the re-ordering step and the inverse quantization step, and the inverse quantization step and the inverse transform step, and the inverse transform step and the compensating step.

5. The method of geometric transformation of claim 1, further comprising a deblock filtering step performed after the geometric transforming step for removing noise from the geometrically transformed data.

6. A video reproduction apparatus including an entropy decoder, re-ordering means, an inverse quantizer, an inverse transformer, inter-reconstruction means, intra-reconstruction means and compensating means for compensating the frames re-constructed by one of the inter-reconstruction means and the intra-reconstruction means with a matrix series obtained by the inverse transformer, characterized in that the video reproduction apparatus further comprises:
a geometric transformer for geometrically transforming the matrix series obtained by the re-ordering means, the inverse quantizer or the inverse transformer, wherein the inter-reconstruction means and the intra-reconstruction means are configured so that the prediction direction and source pixel accessing address are adapted to the geometric transformation performed in the geometric transformer.

7. The video reproduction apparatus of claim 6, wherein the geometric transformer is configured for rotating the matrix series.

8. The video reproduction apparatus of claim 7, wherein the geometric transformer is further configured for mirroring the matrix series.

9. The video reproduction apparatus of claim 6, further comprising a deblock filter coupled to the geometric transformer for removing noise from the geometrically transformed matrix series.

10. The video reproduction apparatus of claim 6, further comprising a memory for saving a current decoded frame.

11. The video reproduction apparatus of claim 10, wherein the memory serves as a display memory.

12. A method of geometric transformation in video reproduction, comprising:
entropy decoding a video input signal comprising a plurality of frames;
re-ordering the entropy decoded signal to generate a first matrix series;
inverse quantization of the first matrix series to generate a second matrix series;
inverse transform of the second matrix series to generate a third matrix series;
inter/intra-reconstruction under the control of the entropy decoded signal to generate reconstructed frames;
compensating the reconstructed frames with the third matrix series; and
geometrically transforming one of the first, second and third matrix series, wherein the inter/intra-reconstruction step is configured so that a prediction direction and source pixel accessing address are adapted to the geometric transformation performed in the geometric transforming step.
